(19) United States
(12) Patent Application Publication
(10) Pub. No.: US 2011/0079415 A1
(43) Pub. Date: Apr. 7, 2011

(54) HOOK AND LOOP ROPE

(76) Inventor: Man-Young JUNG, Pasadena, CA (US)

(21) Appl. No.: 12/572,438

(22) Filed: Oct. 2, 2009

(51) Int. Cl. H01B 3/30; B32B 1/08

(52) U.S. Cl. 174/110 R; 428/34.1

(57) ABSTRACT

A hook and loop rope includes a flexible tube, a strip of loop tape wrapping around the flexible tube in a spiral configuration, and a strip of hook tape wrapping around the flexible tube in a spiral configuration. Optionally, a plurality of internal supporting members can be disposed within the flexible tube. A plurality of internal supporting members can be electrical wire. A stiff tip can be formed on an end of the flexible tube. A first and second slick band can be used for providing slick surfaces on the hook and loop rope. A plurality of internal supporting members disposed within the flexible tube can be electrical wire. A stiff tip can be formed on an end of the flexible tube.

### FIELD OF THE INVENTION

The present invention relates to hook and loop technology.

### DISCUSSION OF RELATED ART

Hook and loop tape has been in use for a wide variety of fastening elements. More recently, advances in hook and loop technology have provided for a wide array of hook and loop configurations. Furthermore, adhesive backing on hook and loop tape provides users with a means for releaseably securing articles to each other or to a structure are frame such as a wall. The hook and loop tape industry has matured over the years and is now mature.

To show the progression of technology, one may consider U.S. Pat. No. 4,001,366 to Brumlik issued Jan. 4, 1977, the disclosure of which is incorporated herein by reference. In Brumlik, self gripping devices have a base that grip to other gripping devices and gripping elements. Later, the hooks engaging with hooks became hooks engaging with loops as described in U.S. Pat. No. 4,654,246 to Provost issued Mar. 31, 1987, the disclosure of which is incorporated herein in its entirety by reference. The basic hook and loop technology being over 20 years old, is now in the public domain, yet recently additional advances in hook and loop technology have invigorated the industry.

One example of a recent advance in hook and loop technology is the production technology system shown in U.S. Pat. No. 6,640,348 to Clune issued Nov. 4, 2003 the disclosure of which is incorporated herein by reference. In Clune, a method of reorienting direct show features associated with manufacture of continuous fastener materials to produce products having such reoriented features is a method which includes the step of forming a continuous preform product having a planar based defining longitudinal edges and an array of fastener elements extending from the base. The disclosure further in discloses that bans of hook and loop tape are angled to allow opposing fastener portions to be presented for fastening with opposite angular orientation to the hook and loop bands.

While mankind has accumulated a substantial amount of knowledge and literature regarding hook and loop technology, the handy ubiquitous fastener can be improved further.

### SUMMARY OF THE INVENTION

The hook and loop tape is wrapped around a core rope section to form an outer layer. A section of bent hook and loop rope can be used for securing articles together, or for securing the rope itself together such as by securing strands of internal supporting members together. Successive bands of hook tape alternate with successive bands of loop tape. The bands of hook tape are parallel to the bands of loop tape. The bands are formed as strips. Strips of loop tape have the same width as the strips of hook tape. In the bent section, looking at the loop tape, it does not fasten with the hook tape. The bent section can be made straight, as well.

In a coiled position, the rope wraps around itself and fastens to itself. The successive strips of hook and loop tape adhere to each other allowing connection of the coil to itself which allows wrapping of one or more articles together with each other, or together with the coil. Looking at a cross section of the present invention would show the hook tape on a hook tape base. The loop tape is formed on a loop tape base. The hook tape base and the loop tape base are adhered to a sheath, which can be made as a flexible tube. The flexible tube includes one or more internal supporting members.

The internal supporting members can be fibers, or metal wire. There can be a first supporting member, a second supporting member, a third supporting member, and a fourth supporting member. A plurality of metal wire can be used as internal supporting members. The plurality of metal wire can be insulated like electrical power lines. If the plurality of metal wire is made as copper, it can conduct electricity. The copper wire can also be used for powering an electronic device. Copper can be a supporting member and disposed internally within the nonconductive tube. A first supporting member can be a red wire for neutral wire, a second supporting member can be a black wire for hot wire, a third supporting member can be a green wire for ground wire, and a fourth supporting member can be a yellow wire for signal. The wire can be regular household current, or low voltage direct current.

In other embodiments, stiffness and resiliency of the internal supporting members may be required. In these cases, a metal internal supporting members such as a thicker copper wire can be fit inside the insulated tube. The internal supporting members can be made so that they are relatively flexible allowing a floppy snakelike and soft hook and loop rope, or in the internal supporting members can be rigid enough to be form retaining, or can also be resilient to maintain a bent or straight shape.

The hook and loop rope can be a power line, which adheres to itself for easy storage. In a laptop computer, power cables are frequently needed for recharging. After recharging the power cables are stowed back into computer bag or carrying case. Easy power cord management and stowage can be accomplished by hook and loop rope. The hook and loop rope maintains itself in a coiled configuration. Power cables usually do not do that on their own. Therefore, hook and loop rope has a variety of different uses.

Sometimes, an external band can be wrapped over the hook and loop tape to provide a slick band. The slick band provides free movement of the hook and loop rope over itself. A number of external bands can be implemented for allowing free movement of the hook and loop rope relative to itself. A top end band can provide slick movement at a top end of the hook and loop rope. A bottom band can provide slick movement at a bottom and of the hook and loop rope. A stiff tip at an upper end can provide a rigid member for attaching to other devices, such as a plug for plugging into a wall socket, or a connector member for connecting to some other article that could use a securing hook and loop rope for additional functionality. A first intermediate band and a second intermediate band can be used for creating a slick gliding area. The first intermediate band and the second intermediate band can overlap to create a unified slick junction at a coil so as to provide slick movement at the unified slick junction.

The top end band can be attached by the method of heat shrinking so as to encapsulate a portion of the hook and loop tape strips to further retain and secure the hook and loop tape strips that form bands on the hook and loop tape rope. The bottom end band and the intermediate bands, may also further retain and secure ends of the hook and loop tape strips. Small gaps between the hook and loop tape strips may arise.

### BRIEF DESCRIPTION OF THE DRAWINGS

The present invention is described by the drawings, briefly described below:

FIG. 1 is a perspective view of the present invention in released configuration.

FIG. 2 is a perspective view of the present invention in coiled configuration.

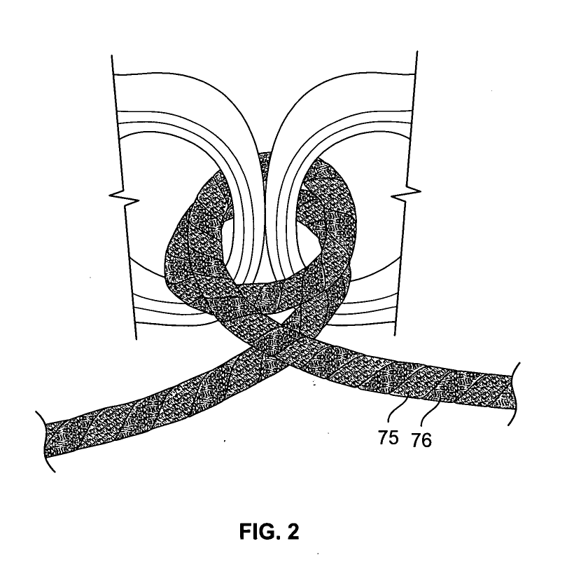

FIG. 3 is a cross section of the present invention.

FIG. 4 is a perspective view of the second embodiment of the present invention in released configuration.

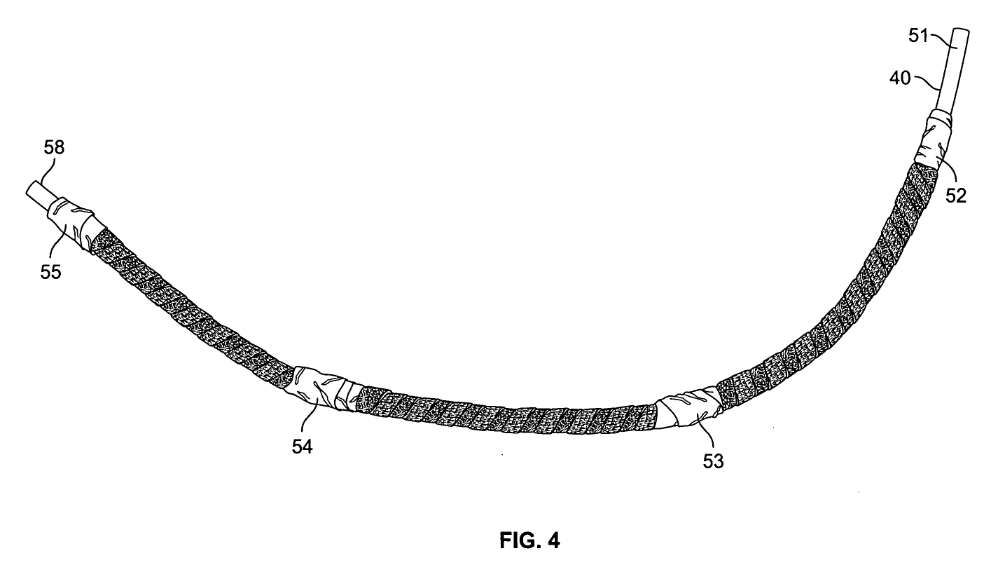

FIG. 5 is a perspective view of the second embodiment of the present invention in coiled configuration.

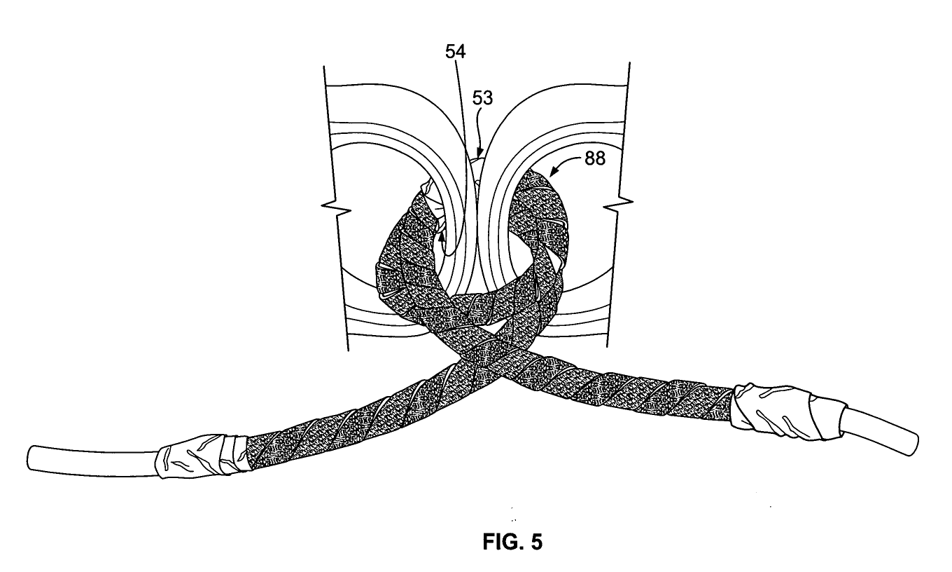

FIG. 6 is a cross section of the second embodiment of the present invention.

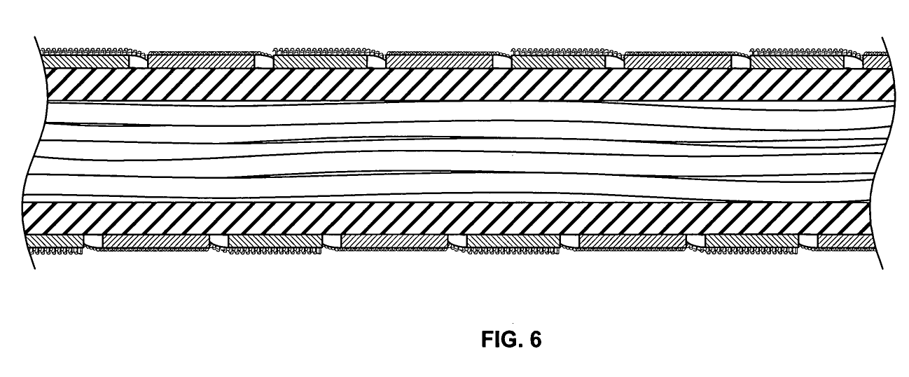

The following call out list of elements is a useful guide in understanding the drawings.
Internal Supporting Members 30
First Internal Supporting Member 31
Second Internal Supporting Member 32
Third Internal Supporting Member 33
Fourth Internal Supporting Member 34
Flexible Tube 40
Stiff Tip 51
Upper End Slick Band 52
First Intermediate Slick Band 53
Second Intermediate Slick Band 54
Lower End Slick Band 55
Hook Tape Support Pad 65
Loop Tape Support Pad 66
Hook Tape 75
Loop Tape 76
Unified Slick Junction 88

### DETAILED DESCRIPTION OF THE PREFERRED EMBODIMENTS

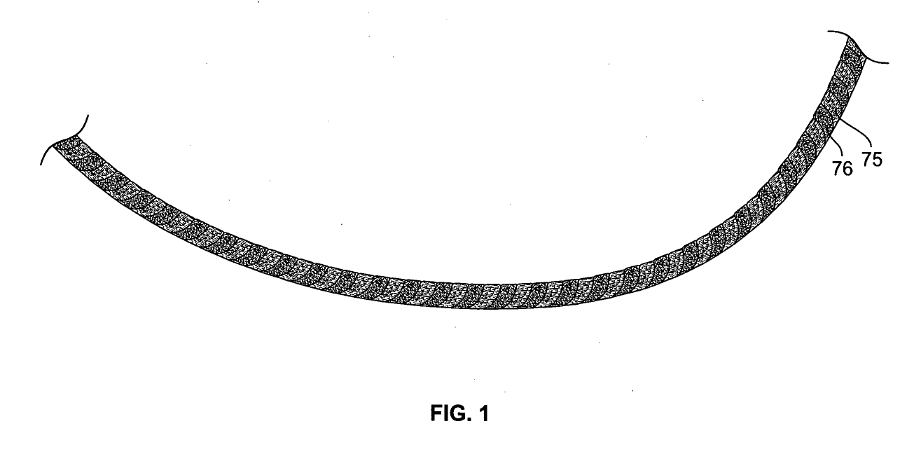

The hook and loop tape is wrapped around a core rope section to form an outer layer. A helical configuration such as a spiral provides coverage. Spiral means going around and upwards like a screw or a spiral staircase. Having a pair of the tape and loop tape in alternation creates a double helix similar to DNA genetic structure. FIG. 1 shows a section of bent hook and loop rope. Successive bands of hook tape 75 alternate with successive bands of loop tape 76. The bands of hook tape 75 are parallel to the bands of loop tape 76. The bands are formed as strips. Strips of loop tape 76 have the same width as the strips of hook tape 75. In the bent section, looking at the loop tape, it does not fasten with the hook tape. The bent section can be made straight, as well.

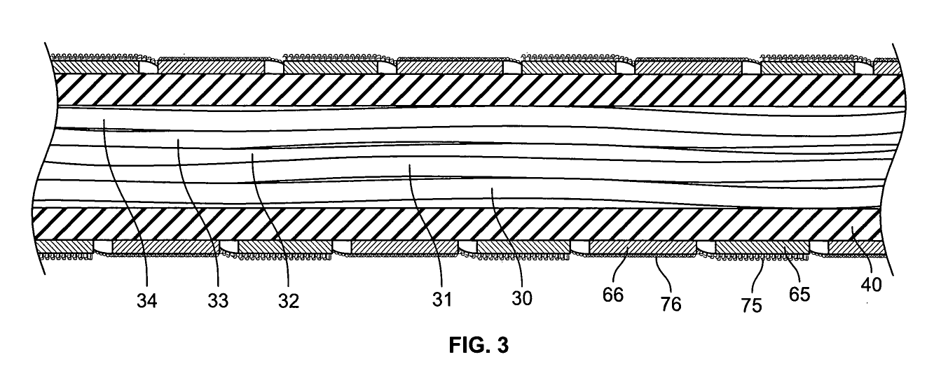

In a coiled position, the rope wraps around itself and fastens to itself. The successive strips of hook and loop tape adhere to each other allowing connection of the coil to itself which allows wrapping of one or more articles together with each other, or together with the coil. FIG. 3 is a cross section of the present invention showing the hook tape on a hook tape base 65. The loop tape is formed on a loop tape base 66. The hook tape base and the loop tape base are adhered to a sheath 40, which can be made as a flexible tube 40. The flexible tube 40 includes one or more internal supporting members 30. Flexible means that it can be bent.

The internal supporting members 30 can be fibers, or metal wire. There can be a first supporting member 31, a second supporting member 32, a third supporting member 33, and a fourth supporting member 34. A plurality of metal wire can be used as internal supporting members. The plurality of metal wire can be insulated like electrical power lines. If the plurality of metal wire is made as copper, it can conduct electricity. The copper wire can also be used for powering an electronic device. Copper can be a supporting member and disposed internally within the nonconductive tube. A first supporting member can be a red wire for neutral wire, a second supporting member can be a black wire for hot wire, a third supporting member can be a green wire for ground wire, and a fourth supporting member can be a yellow wire for signal.

In other embodiments, stiffness and resiliency of the internal supporting members may be required. In these cases, a metal internal supporting members such as a thicker copper wire can be fit inside the insulated tube. The internal supporting members can be made so that they are relatively flexible allowing a floppy snakelike and soft hook and loop rope, or in the internal supporting members can be rigid enough to be form retaining, or can also be resilient to maintain a bent or straight shape.

The hook and loop rope can be a power line, which adheres to itself for easy storage. In a laptop computer, power cables are frequently needed for recharging. After recharging the power cables are stowed back into computer bag or carrying case. Easy power cord management and stowage can be accomplished by hook and loop rope. The hook and loop rope maintains itself in a coiled configuration. Power cables usually do not do that on their own. Therefore, hook and loop rope has a variety of different uses.

Sometimes, an external band can be wrapped over the hook and loop tape to provide a slick band. The slick band provides free movement of the hook and loop rope over itself. A number of external bands can be implemented for allowing free movement of the hook and loop rope relative to itself. A top end band 52 can provide slick movement at a top end of the hook and loop rope. A bottom band 55 can provide slick movement at a bottom and of the hook and loop rope. A stiff tip 51 at an upper end can provide a rigid member for attaching to other devices, such as a plug for plugging into a wall socket, or a connector member for connecting to some other article that could use a securing hook and loop rope for additional functionality. A stiff tip 51 can be formed by the exposure of the flexible tube 40 from the hook and loop strips. A first intermediate band 53 and a second intermediate band 54 can be used for creating a slick gliding area. The first intermediate band 53 and the second intermediate band 54 can overlap to create a unified slick junction 88 at a coil so as to provide slick movement at the unified slick junction 88.

The top end band 52 can be attached by the method of heat shrinking so as to encapsulate a portion of the hook and loop tape strips to further retain and secure the hook and loop tape strips that form bands on the hook and loop tape rope. The bottom end band 55 and the intermediate bands 53, 54 may also further retain and secure ends of the hook and loop tape strips. Small gaps between the hook and loop tape strips may arise. Slick means that the surface does not fasten to the hook or loop tape strips.

During use, a power cord which is made into a hook and loop rope can be wrapped around external support structures such as hooks, door handles, frame members, or other environmental structures. The user can take the power cord off of the environmental structure as well. With light products, such as small portable electronic devices, a power cord could have enough strength to hold the device. For heavier machinery, using the power cord would not be enough. The hook and loop rope could be used on the power cord for heavier machinery so as to organize the power cord, but not used for hanging heavier machinery from the wall or from other environmental structures.

The power cord could also be independent of the hook and loop rope. The hook and loop rope can be used by attaching to a flashlight for example, and having the flashlight wrap around a tree branch during outdoor use such as camping or outdoor repairs at night. The hook and loop rope can also coil around itself for storage when not in use.

In summary, the hook and loop rope includes a flexible tube, a strip of loop tape wrapping around the flexible tube in a spiral configuration, and a strip of hook tape wrapping around the flexible tube in a spiral configuration. Optionally, a plurality of internal supporting members can be disposed within the flexible tube. A plurality of internal supporting members can be electrical wire. A stiff tip can be formed on an end of the flexible tube. A first and second slick band can be used for providing slick surfaces on the hook and loop rope. A plurality of internal supporting members disposed within the flexible tube can be electrical wire. A stiff tip can be formed on an end of the flexible tube.

1. A hook and loop rope comprising:
a. a flexible tube;
b. a strip of loop tape wrapping around the flexible tube in a spiral configuration;
c. a strip of hook tape wrapping around the flexible tube in a spiral configuration.

2. The hook and loop rope of claim 1, further comprising a plurality of internal supporting members disposed within the flexible tube.

3. The hook and loop rope of claim 1, wherein the plurality of internal supporting members are electrical wire.

4. The hook and loop rope of claim 1, further comprising a stiff tip formed on an end of the flexible tube.

5. The hook and loop rope of claim 1, further comprising a first slick band.

6. The hook and loop rope of claim 5, further comprising a second slick band.

7. The hook and loop rope of claim 1, further comprising a plurality of internal supporting members disposed within the flexible tube, The hook and loop rope of claim 1, wherein the plurality of internal supporting members are electrical wire, The hook and loop rope of claim 1, further comprising a stiff tip formed on an end of the flexible tube.

8. The hook and loop rope of claim 7, further comprising a first slick band.

9. The hook and loop rope of claim 8, further comprising a second slick band.

10. A hook and loop rope comprising:
a. a flexible tube;
b. a strip of loop tape wrapping around the flexible tube in a spiral configuration;
c. a strip of hook tape wrapping around the flexible tube in a spiral configuration, wherein the strip of loop tape alternates with the strip of hook tape to provide a spiral double helix geometric configuration.

11. The hook and loop rope of claim 10, further comprising a plurality of internal supporting members disposed within the flexible tube.

12. The hook and loop rope of claim 10, wherein the plurality of internal supporting members are electrical wire.

13. The hook and loop rope of claim 10, further comprising a stiff tip formed on an end of the flexible tube.

14. The hook and loop rope of claim 10, further comprising a first slick band.

15. The hook and loop rope of claim 10, further comprising a second slick band.

16. The hook and loop rope of claim 10, wherein the plurality of internal supporting members are electrical wires, wherein the electrical wires include a hot wire, a neutral wire, and a ground wire.

17. The hook and loop rope of claim 10, wherein the plurality of internal supporting members are electrical wires, wherein the electrical wires include a hot wire, a neutral wire, a single wire and a ground wire.

18. The hook and loop rope of claim 17, further comprising a stiff tip formed on an end of the flexible tube, further comprising a first slick band.
